(19) United States
(12) Patent Application Publication
(10) Pub. No.: US 2011/0009024 A1
(43) Pub. Date: Jan. 13, 2011

(54) ROOF UNDERLAYMENT

(75) Inventor: Eric Clark, Bossier City, LA (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 12/826,508

(22) Filed: Jun. 29, 2010

Related U.S. Application Data
(60) Provisional application No. 61/222,401, filed on Jul. 1, 2009.

(51) Int. Cl. B32B 5/26; B32B 3/26

(52) U.S. Cl. 442/381; 428/316.6

(57) ABSTRACT

A roofing underlayment sheet includes several layers. Some of the layers are made of polymeric materials. Other of the layers are made of non-woven materials.

### PRIORITY CLAIM

This application claims priority under 35 U.S.C. §119(e) to U.S. Provisional Application Ser. No. 61/222,401, filed Jul. 1, 2009, which is expressly incorporated by reference herein.

### BACKGROUND

The present disclosure relates to water barrier systems, and particularly to a roofing underlayment. More particularly, the present disclosure relates to a multi-layer roofing underlayment.

A roofing underlayment is a water-barrier system that is placed on top of a commercial or household structure to block entry of water from rain or snow into the structure during a structure-construction phase. This allows construction to continue before a roof is laid on the roofing underlayment at a later time.

### SUMMARY

A roofing underlayment sheet in accordance with the present disclosure includes several layers. In illustrative embodiments, the roofing underlayment sheet includes first, second, and third layers wherein the third layer is made of a woven or non-woven material to provide a base for the first and second layers and each of the first and second layers is hydrophobic and is made of a polymeric material formulation including silicone. In illustrative embodiments, the sheet also includes fourth and fifth layers wherein the fifth layer is made of a non-woven material and is adapted to mate with a roof deck in a commercial or residential structure and the fourth layer is hydrophobic and is made of a polymeric material formulation including silicone.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is an exploded perspective view of portions of each of five layers included in an illustrative multi-layer roofing underlayment sheet arranged to lie above a portion of a plywood deck included in a commercial or residential structure, wherein an illustrative sheet comprises (from top to bottom) a hydrophobic first layer, a hydrophobic second layer, a third layer made of a woven material, a hydrophobic fourth layer, and a fifth layer made of a non-woven material, wherein each of the hydrophobic first, second, and fourth layers is a polymeric material formulation including silicone;

FIG. 2 is a perspective view of the multi-layer roofing underlayment sheet of FIG. 1 at rest on the plywood deck of FIG. 1, with portions broken away, showing (diagrammatically) rain droplets that have puddled on top of the hydrophobic first layer, smaller water droplets/molecules that have flowed through the hydrophobic first layer and puddled on top of the hydrophobic second layer, and still smaller water droplets/molecules that have flowed through the first, second, and third layers and puddled on top of the hydrophobic fourth layer;

FIG. 3 is an enlarged sectional view taken along line 3-3 of FIG. 2 showing that water droplets/molecules have puddled on top of each of the hydrophobic first, second, and fourth layers of the multi-layer roofing underlayment sheet owing to a silicone-based formulation of the polymeric materials used to make the first, second, and fourth layers; and

FIG. 4 is an enlarged sectional view taken along line 4-4 of FIG. 2 showing a left-side roofing nail passing through the multi-layer roofing underlayment sheet into the plywood deck and having an exposed nail head pressing downwardly into the hydrophobic first layer to create a sealed connection between the nail head and the hydrophobic first layer and showing a neighboring right-side roofing nail passing through the multi-layer roofing underlayment sheet into the plywood deck and having an exposed nail head separated from the underlying hydrophobic first layer to illustrate a condition in which no sealed connection is established between the nail head and the hydrophobic first layer.

### DETAILED DESCRIPTION

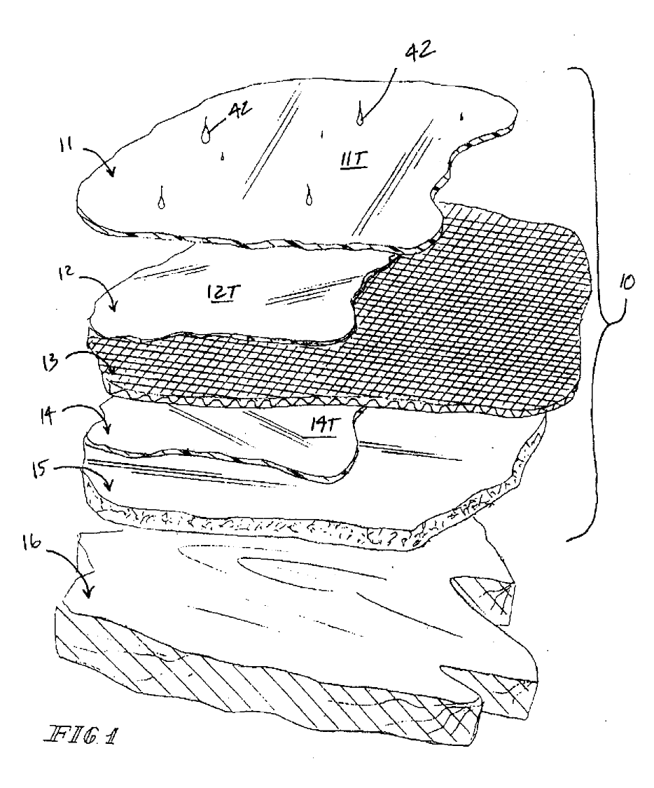

A roofing underlayment sheet 10 includes several layers 11, 12, 13, 14, and 15 and is adapted to be mounted on a roof deck 16 of a commercial or residential structure as suggested in FIGS. 1-4. In an illustrative embodiment, first, second, and fourth layers 11, 12, and 14 are made of a polymeric material formulation including silicone and thus configured to repel rain water.

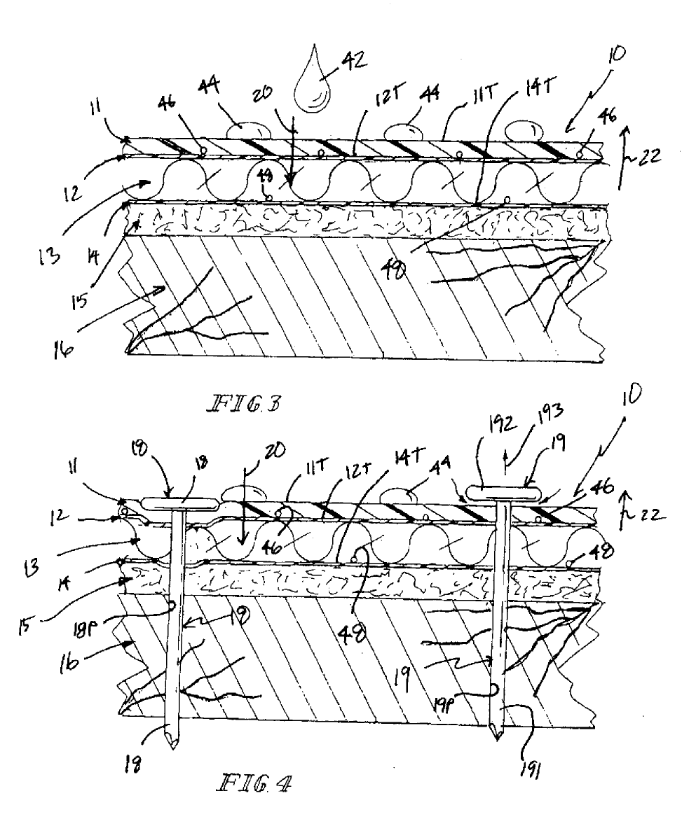

In an illustrative embodiment, roofing underlayment sheet 10 is imperforate as suggested in FIGS. 1-3. Sheet 10 can be coupled to roof deck 16 using roofing nails 18, 19 as suggested in FIG. 4. Sheet 10 can also be coupled to roof deck 16 using an adhesive or other suitable means. Roof deck 16 is made of plywood in an illustrative embodiment.

First layer 11 is a breathable membrane that is arranged to serve as the outer skin of sheet 10. First layer 11 is exposed to weather until a roof (not shown) is laid thereon. First layer 11 is configured to provide means for blocking high-speed penetration of water (e.g., rain, snow) from the atmosphere into remaining layers 12-15 of sheet under, for example, wind-driven conditions. First layer 11 is configured to provide means for allowing moisture vapor to pass in an outbound direction 20 from second layer 12 to atmosphere 100 beyond first layer 11 in predetermined measured quantities. First layer 11 can be configured to provide anti-skid characteristics in accordance with the disclosure in U.S. application Ser. No. 11/752703, filed May 23, 2007, which application is hereby incorporated by reference herein. In an illustrative embodiment, first layer 11 is made of a polymeric material formulation including silicone.

Second layer 12 is a breathable tie layer that is arranged to provide means for interconnecting (tying together) first and third layers 11, 13 to establish a pliable multi-layer mat 11, 12, 13 as suggested in FIGS. 1-4. Second layer 12 is configured to provide means for allowing moisture vapor to pass in outbound direction 22 from third layer 13 to first layer 11 in predetermined measured quantities. In an illustrative embodiment, second layer 12 is made of a polymeric material formulation comprising a polymer and additives, such as calcium carbonate, blowing agents, spherical beads, and silicone to provide means for assisting in maintaining an open structure in second layer 12 to allow for flow of moisture vapor in outbound direction 22 and provided additional water hold-out properties for roofing underlayment sheet 10.

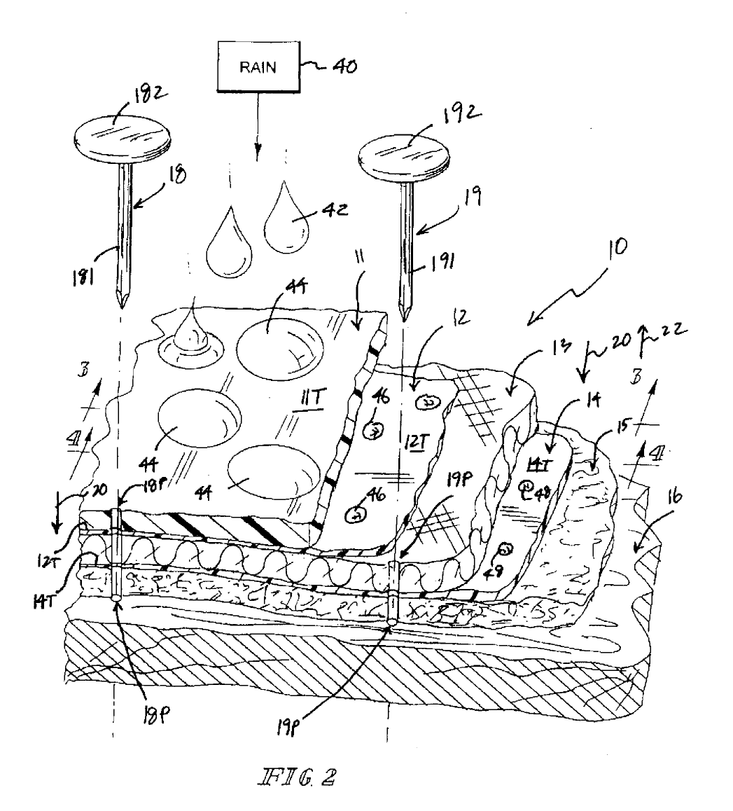

Third layer 13 is a breathable base layer and is configured to provide most of the physical properties of roofing underlayment sheet 10 as suggested in FIGS. 1 and 2. In illustrative embodiments, third layer 13 is either a woven, composite, or non-woven polymeric material configured to allow moisture vapor to pass in outbound direction 22 from fourth layer 14 to second layer 12.

Fourth layer 14 is a breathable tie layer that is arranged to provide means for interconnecting (tying together) third and fifth layers 13, 15 as suggested in FIGS. 1-4. Fourth layer 14 is configured to provide means for allowing moisture vapor to pass in outbound direction 22 from fifth layer 15 to third layer 13 in predetermined measured quantities. In an illustrative embodiment, fourth layer 14 is made of a polymeric material formulation including silicone.

Fifth layer 15 is a breathable membrane that is arranged to serve as the inner skin of sheet 10 in an illustrative embodiment. Fifth layer 15 is laid on plywood roof deck 16 as shown, for example, in FIGS. 1-4. In an illustrative embodiment, fifth layer 15 is made of a non-woven deck felt material.

In illustrative embodiments, roofing underlayment sheet 10 includes all five layers 11, 12, 13, 14, and 15. In other embodiments, a roofing underlayment sheet in accordance with the present disclosure is provided by a mat comprising layers 11, 12, and 13.

A characteristic common to hydrophobic first, second, and fourth layers 11, 12, and 14 is that the polymeric material formulation for each of layers 11, 12, and 14 includes silicone. Silicone in its solid state is added to the layer formulations in accordance with the present disclosure to cause each of these layers 11, 12, and 14 to repel water by inducing water droplets/molecules resulting from rain that has fallen onto sheet 10 to bead up on contact with outer surfaces of each of hydrophobic first, second, and fourth layers 11, 12, and 14 and roll away without penetrating further in inbound direction 20 toward roof deck 16 into lower layers of sheet 10.

The addition of silicone to the polymeric material formulation of each of layers 11, 12, and 14 is believed to alter the surface chemistry of top surface 11T, 12T, and 14T of those layers 11, 12, and 14 so as to decrease the surface tension of molecules comprising the top layers. Water droplets/molecules move in the inbound direction 20 and land on (arrive at) top surfaces 11T, 12T, and 14T as suggested in FIGS. 2-4. If a water droplet/molecule has a high surface tension at the interface with each of layers 11, 12, and 14, the water droplet/molecule will bead up and not spread out along the expanse of the top surface. Adding silicone to the polymeric material formulation of each layer 11, 12, and 14 causes each layer to become more hydrophobic by increasing the differential surface energy between layer 11, 12, and 14 and water droplets/molecules on top surfaces 11T, 12T, and 14T of layers 11, 12, and 14.

Silicone is used in first, second, and fourth layers 11, 12, and 14 to make each of those layers more hydrophobic. As compared to other materials, such a fluorine solid-state silicone bond well to neighboring materials and is printable.

In other illustrative embodiments, low surface energy nanoparticles could be used in layers 11, 12, and 14 instead of or in addition to solid silicone particles to repel water flow through the multi-layer system.

As suggested diagrammatically in FIG. 2 (see also FIGS. 3 and 4), rain 40 produces rain drops 42 that fall toward roofing underlayment sheet 10. Water droplets/molecules 44 are formed on top surface 11T of hydrophobic first layer 11 of sheet 10 as suggested diagrammatically in FIGS. 2-4. These water droplets/molecules 44 will roll away along top surface 11T and not move further in inbound direction 20 toward roof deck 16.

Water that does move in inbound direction 20 to exit first layer 11 will tend to bead up upon arrival at top surface 12T of hydrophobic second layer 12 and form water droplets/molecules 46 on top surface 12T as suggested in FIGS. 2-4. Although some water may penetrate first layer 11 and arrive at top surface 12T of second layer 12, water droplets/molecules 44 will bead up and roll away along top surface 12T and not move further in inbound direction 20 toward roof deck 16.

There is perhaps some water that does move further in inbound direction 20 to penetrate second and third layers 12, 13 and arrive at top surface 14T of hydrophobic fourth layer 14 and form water droplets/molecules 48 on top surface 14T as suggested in FIGS. 2-4. These water droplets/molecules 48 will roll away along top surface 14T and not move further in inbound direction 20 toward roof deck 16.

As suggested in FIGS. 2 and 4, roofing nails 18, 19 are used in an illustrative embodiment to anchor roofing underlayment sheet 10 to roof deck 16. During installation, nail 18 pierces sheet 10 to produce nail-receiving passageway 18P and nail 19 pierces sheet 10 to produce nail-receiving passageway 19P. As suggested in FIG. 4, nail 18 is installed properly so that shaft 181 pierces sheet 10 to create passageway 18P and head 182 mates with and deforms on or more outer layer(s) of sheet 10 to establish a water seal therebetween to block flow of water from raindrops 42 in inbound direction 20 through passageway 18P toward roof deck 16.

Roofing nail 19 has been moved outwardly in direction 193 as suggested in FIG. 4 to separate nail head 192 from top surface 11T of first layer 11 of sheet 10. Such outward movement of nail head 192 could occur in the field or in a test situation for a variety of reasons and could break a water seal established between nail head 192 and roofing underlayment sheet 10. If such a water seal were to be broken and water associated with raindrops 42 were to flow in inbound direction 20, some of that water would flow through, for example, first layer 11 to reach top layer 12T of second layer 12 and top layer 14T of fourth layer 14. Water reaching those top layers 12T, 14T would bead up and roll away along those layers 12T, 14 and not progress further through passageway 19P in inbound direction toward roof deck 16. This enhances the water barrier feature established by the roofing underlayment sheet 10 in accordance with the present disclosure.

1. A multi-layer roofing underlayment sheet comprising
a first layer made of a polymeric material formulation including silicone in its solid state to provide means for causing water exposed to a top surface of the first layer to bead up without spreading out along the top surface of the first layer and arranged to provide an outer skin of the sheet,
a third layer made of a polymeric material and arranged to provide a base of the sheet, and
a second layer interposed between the first and third layers and configured to interconnect the first and third layers to provide a pliable mat, wherein the first layer is configured to provide means for blocking high-speed penetration of water from the atmosphere in an inbound direction into the second layer through the first layer and for allowing moisture vapor to pass in an outbound direction opposite to the inbound direction from the second layer through the first layer to the atmosphere, the second layer is configured to provide means for allowing moisture vapor to pass in the outbound direction from the third layer to the first layer, and the second layer is made of a polymeric material formulation including silicone in its solid state to provide means for causing water exposed to a top surface of the second layer facing toward the first layer to bead up without spreading out along the top surface of the second layer.

2. The sheet of claim 1, wherein the sheet further comprises
a fifth layer arranged to provide an inner skin of the sheet and adapted to mate with a plywood roof deck and
a fourth layer interposed between the third and fifth layers and configured to interconnect the third and fifth layers, and wherein the fourth layer is configured to provide means for allowing moisture vapor to pass in the outbound direction from the fifth layer to the third layer and the fourth layer is made of a polymeric material formulation including silicone in its solid state to provide means for causing water exposed to a top surface of the fourth layer facing toward the third layer to bead up without spreading out along the top surface of the fourth layer.

3. A multi-layer roofing underlayment sheet comprising, in sequence, a hydrophobic first layer, a hydrophobic second layer, a third layer made of a non-woven material, a hydrophobic fourth layer, and a fifth layer made of a non-woven material and adapted to mate with a plywood roof deck, wherein each of the hydrophobic first, second, and fourth layers is a polymeric material formulation including silicone in its solid state.
